(19) United States
(12) Patent Application Publication
(10) Pub. No.: US 2023/0316104 A1
(43) Pub. Date: Oct. 5, 2023

(54) MACHINE LEARNING SYSTEMS AND METHODS FOR DOCUMENT RECOGNITION AND ANALYTICS

(71) Applicant: Samu Legal Technologies, LLC, St. Louis, MO (US)

(72) Inventor: Joseph Angelo Ott, St. Louis, MO (US)

(21) Appl. No.: 18/192,580

(22) Filed: Mar. 29, 2023

Related U.S. Application Data
(60) Provisional application No. 63/325,024, filed on Mar. 29, 2022.

(51) Int. Cl. G06N 5/022

(52) U.S. Cl. CPC G06N 5/022

(57) ABSTRACT

An analytics computing device is provided. The analytics computing device may include a processor in communication with a memory. The processor may (1) store, in the memory, a plurality of documents in association with a case identifier; (2) electronically extract content data from the plurality of documents using a semantic analysis engine; (3) generate a case record in the memory including the extracted content data associated with the case identifier, the case record having a predefined data format; (4) execute a machine learning model configured to output a predicted value amount by inputting at least a portion of the extracted content data included in the case record into the machine learning model, the machine learning model trained using a plurality of historical case records and a plurality of historical value amounts; and/or (5) cause the predicted value amount outputted by the machine learning model to be displayed.

### CROSS-REFERENCE TO RELATED APPLICATIONS

This application claims the benefit of priority to U.S. Provisional Patent Application No. 63/325,024, filed Mar. 29, 2022, the contents and disclosures of which are hereby incorporated by reference in their entirety.

### FIELD OF USE

The present disclosure relates to machine learning and document analytics and, more particularly, to systems and methods that utilize machine learning (ML) techniques to analyze documents and/or voice data to generate prediction analysis of the documents and/or the voice data.

### BACKGROUND

Many fields require a review and analysis of a large volume of documents. For example, in the financial, insurance, and/or legal industries, such documents may require review in order to obtain information needed for a transaction or case. Computers are sometimes utilized to assist with such review and analysis. For example, certain tools such as optical character recognition (OCR), document scanning, and/or electronic word searches are sometime used to determine what a document relates to and obtain information from the document. However, computers generally do not have a capability to semantically understand information included in such documents, and accordingly, computer systems generally are not capable of automating or otherwise executing the process of reviewing and analyzing documents without significant humans input.

Similarly financial, insurance and legal industries require significant ongoing contact between agents and their clients. Computers are used to facilitate this contact by providing transmission of messages through VOIP. Although call recording is a frequently employed method for retaining such conversations, the analysis of large datasets containing voluminous call logs remains difficult. Computers are generally not capable of automating the analysis of call logs and extracting information relevant to decision making without reference to human created notes.

For example, in the legal industry, computers may be needed to quickly track and store data relating to legal cases. This data may include electronically storable documents, correspondence (e.g., telephone calls and/or emails), and other data relating to the case. For example, a personal injury case may be associated with many different entities (e.g., plaintiff, defendant, attorneys, medical providers, witnesses, insurance providers) and many different documents (e.g., litigation related-documents, medical records, client intake forms, correspondence). These documents must generally be manually labeled and organized within the computer system by attorneys or other legal professionals.

Similarly in the legal industry, computers are frequently used to facilitate conversations between attorneys and their employees or agents and clients. Computers are used to track and store data relating to phone calls. Sometimes, humans are create notes in computer databases related to individual calls. Calls may be made to numerous entities (e.g., plaintiff, defendant, attorneys, medical providers, witnesses, insurance providers) in furtherance of cases for individual clients. But, the calls must be manually organized and associated by attorneys and their staff with the entities, and the purpose of the calls as well as their content and relevance to the legal cases must be manually noted and organized.

The documents and conversations related to legal cases are themselves related to each other. The conversations when transcribed form a core record of the interactions underlying the attorney client relationship and contain confidential information that is at present typically only available to the participants in the conversation. The determination that a document is relevant to a legal case must be made on the basis of the information derived from the conversation with the client. Attorneys or their staff not present for client conversations are forced to rely upon inference and experience to determine the optimal strategy for pursuing a case, impacting the quality of the representation and creating inefficiencies.

The documents and conversations related to a legal case comprise the facts. Attorneys, financial analysts and insurance companies strategically use facts to advise client in a matter. Devising and executing an optimal strategy when there is single employee working with a single person is well understood. But now multiple attorneys, advisors and insurance professionals together with their staff work with client's that are sometimes composed of many people. In this context reducing uncertainty created by alternative plausible inferences from a given set of facts undermines a cohesive strategy and therefore zealous advocacy.

It is therefore desirable to have a computer system configured to build a model that is configured to analyze the content of documents and client conversations to determine the actual content of the documents and conversations, label those documents and conversations, determine a potential value of the content of the document and conversations, and output a recommendation including next steps in trying to obtain that potential value.

### BRIEF SUMMARY

In one aspect, an analytics computing device is provided. The analytics computing device may include a processor in communication with a database. The processor may be configured to store, in the database, a plurality of documents relating to a case, extract content data from the plurality of documents using a semantic analysis, store the extracted content data in the database, and generate at least one prediction relating to an outcome of the case, the prediction including a predicted case value amount.

In another aspect, a computer-implemented method is provided. The computer-implemented method may be performed by an analytics computing device including a processor in communication with a database. The method may include storing, by the analytics computing device, in the database, a plurality of documents relating to a case, extracting, by the analytics computing device, content data from the plurality of documents using a semantic analysis, storing, by the analytics computing device, the extracted content data in the database, and generating, by the analytics computing device, at least one prediction relating to an outcome of the case, the prediction including a predicted case value amount.

In another aspect, at least one non-transitory computer-readable media having computer-executable instructions embodied thereon is provided. When executed by an analytics computing device including a processor in communication with a database, the computer-executable instructions may cause the processor to store, in the database, a plurality of documents relating to a case, extract content data from the plurality of documents using a semantic analysis, store the extracted content data in the database; and generate at least one prediction relating to an outcome of the case, the prediction including a predicted case value amount.

In another aspect, an analytics computing device is provided. The analytics computing device may include processor in communication with a memory. The processor may be configured to store, in the memory, a plurality of documents in association with a case identifier. The processor may be further configured to electronically extract content data from the plurality of documents using a semantic analysis engine. The processor may be further configured to generate a case record in the memory including the extracted content data associated with the case identifier. The case record may have a predefined data format. The processor may be further configured to execute a machine learning model configured to output a predicted value amount by inputting at least a portion of the extracted content data included in the case record into the machine learning model. The machine learning model may be trained using a plurality of historical case records and a plurality of historical value amounts associated with the historical case records. The historical case records may include historical content data and have the predefined data format. The processor may be further configured to cause the predicted value amount outputted by the machine learning model to be displayed.

In another aspect, a computer-implemented method is provided. The computer-implemented method may be performed by an analytics computing device including a processor in communication with a memory. The computer-implemented method may include storing, by the analytics computing device, in the memory, a plurality of documents in association with a case identifier. The computer-implemented method may further include electronically extracting, by the analytics computing device, content data from the plurality of documents using a semantic analysis engine. The computer-implemented method may further include generating, by the analytics computing device, a case record in the memory including the extracted content data associated with the case identifier. The case record may have a predefined data format. The computer-implemented method may further include executing, by the analytics computing device, a machine learning model configured to output a predicted value amount by inputting at least a portion of the extracted content data included in the case record into the machine learning model. The machine learning model may be trained using a plurality of historical case records and a plurality of historical value amounts associated with the historical case records. The historical case records may include historical content data and have the predefined data format. The computer-implemented method may further include causing, by the analytics computing device, the predicted value amount outputted by the machine learning model to be displayed.

In another aspect, at least one non-transitory computer-readable media having computer-executable instructions embodied thereon is provided. When executed by an analytics computing device including a processor in communication with a memory, the computer-executable instructions may cause the processor to store, in the memory, a plurality of documents in association with a case identifier. The computer-executable instructions may further cause the processor to electronically extract content data from the plurality of documents using a semantic analysis engine. The computer-executable instructions may further cause the processor to generate a case record in the memory including the extracted content data associated with the case identifier. The case record may have a predefined data format. The computer-executable instructions may further cause the processor to execute a machine learning model configured to output a predicted value amount by inputting at least a portion of the extracted content data included in the case record into the machine learning model. The machine learning model may be trained using a plurality of historical case records and a plurality of historical value amounts associated with the historical case records. The historical case records may include historical content data and have the predefined data format. The computer-executable instructions may further cause the processor to cause the predicted value amount outputted by the machine learning model to be displayed.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts an example analytics system in accordance with an example embodiment of the present disclosure.

FIG. 2 depicts an example client computing device that may be used with the analytics system illustrated in FIG. 1.

FIG. 3 depicts an example server system that may be used with the analytics system illustrated in FIG. 1.

FIG. 4 depicts an example process for inputting a document into the analytics system illustrated in FIG. 1.

FIG. 5A depicts an example machine learning system that may be implemented using the analytics system illustrated in FIG. 1.

FIG. 5B is a continuation of the machine learning system depicted in FIG. 5A.

FIG. 6 depicts a screenshot of an example login screen for a file management application in accordance with an example embodiment of the present disclosure.

FIG. 7 depicts another screenshot of the file management application illustrated in FIG. 6.

FIG. 8 depicts another screenshot of the file management application illustrated in FIGS. 6 and 7.

FIG. 9A illustrates an example computer-implemented method that may be performed using the analytics system illustrated in FIG. 1.

FIG. 9B is a continuation of the computer-implemented method shown in FIG. 9A.

FIG. 10 illustrates another example computer-implemented method that may be performed using the analytics system illustrated in FIG. 1.

FIG. 11 is an example neural network architecture that may be used by the analytics system illustrated in FIG. 1.

FIG. 12 illustrates an example data structure for training a neural network model that may be used by the analytics system illustrated in FIG. 1.

FIG. 13 is an example pseudocode that can be used to build a neural network model that may be used by the analytics system illustrated in FIG. 1.

FIG. 14 is a flow diagram illustrating an example application of the analytics system illustrated in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to systems and methods for document analytics and computer-implemented case management applications implemented using document analytics. The system may receive, extract, and/or collect content data, or data associated with a case that is derived from documents relating to the case, from various sources (e.g., documents, images, and/or recordings). In some example embodiments, AI and/or ML techniques may be utilized to extract the content data from these various sources. The content data may further be analyzed using, for example, AI and/or ML techniques to predict a case value amount, or a value (e.g., a potential financial recovery amount) of one or more potential outcomes of the case (e.g., a likelihood of success of a certain party, a likelihood of the case proceeding to a certain stage, a settlement amount, and/or other potential outcomes). This analysis may further be used for computer-implemented case management functions such as, for example, identifying missing content data (e.g., medical records) that would be helpful for predicting an outcome of the case, generating requests for missing content data and/or identifying actions that may be taken to obtain missing content data, generating tasks and/or reminders, generating emails and/or case documents, and/or managing information regarding clients and file management. In some embodiments, the system may generate and/or display one or more reports for a given case and/or aggregate groups of cases, as described in further detail below, that include the predicted case value and/or other information relating to the case and/or aggregated cases (e.g., missing documents and/or information needed to improve the evaluation of the case). Such reports may be used by an attorney and/or potential client, for example, to help in obtaining financing for a case and/or group of cases. The prediction may be regenerated continuously, periodically, or intermittently (e.g., in response to input of new content data), so that the current or instantaneous case value amount reflects all of the currently available data and corresponds to a value of the case at the time of the analysis.

In an example embodiment, the process is performed by an analytics computing device. The analytics computing device may include a processor in communication with a database or other memory. The database may be configured to store documents relating to a case and/or data (e.g., content data) extracted therefrom, as described in further detail below.

In the example embodiment, the analytics computing device may be configured to receive documents and store the received documents in the database. As described below, the documents may be submitted electronically (e.g., via scanning or transmitting via a connected computer), and may be analyzed using OCR, natural word analysis, sentiment analysis, image recognition, or other computer-executable analytic processes that may make determinations about contents of the received documents. The analytics computing device may identify documents (e.g., using relating to a particular case (e.g., being associated with a case identifier relating to the case) and store the documents in association with each other and a corresponding case file, as described in further detail below. These documents may include, for example, documents (e.g., written statements made by witnesses), records (e.g., medical, police, and/or insurance records), images, audio and/or video records, electronic communication (e.g., emails and/or text messages), and/or other types of documents that may be stored electronically at least to an extent. The documents may be received, for example, by being uploaded by a user (e.g., though a web-based and/or application-based portal), by retrieving and/or scraping data from telephone calls, emails, and/or other electronic correspondence, and/or by querying external databases.

Because the documents may be stored in any of a variety of different file types and/or formats, the processor may be configured to extract content data from these documents and store the extracted content data in a case record having a specific predefined data format. For example, in some embodiments, the processor may be configured to apply OCR programs to documents such as portable document format (PDF) files (e.g., scans of documents) to extract text data from the documents, and to run a specified machine learning flow (e.g., depending on the document type) to extract content data from the text. For example, when analyzing medical records, the machine learning flow may utilize a medical ontology vocabulary, which semantically defines terms that may be found within the text, to parse the text data for medical information. In other words, certain terms or combinations of terms within the text may be identified as corresponding to certain medical information, and this medical information may then be stored as content data in a predefined format. In some embodiments, in addition to documents, the processor may be configured to generate text data from audio sources (e.g., recorded telephone calls and/or other statements) using, for example, speech-to-text programs, and process the text data using the machine learning flow as described above to generate content data. Such data may additionally be used as training data, which the processor may use to continually refine the machine learning model that extracts data from the documents.

In the example embodiment, once the content data has been extracted from the documents and stored in the database, the processor may be configured to develop a model that links the occurrence of certain extracted content data with case outcomes (e.g., a settlement and/or value received amount). For example, the extracted content data and historical case outcomes may be used as training data to train an ML model, and the ML model may then be used to predict future case outcomes based on content data corresponding to current cases utilizing correlations identified between the occurrence of certain content data and certain case outcomes. The ML model may include clusters of similar patterns of content data, and upon receiving input content data, compare the input content data to the clusters to identify similar clusters and generate predictions based on historical outcomes associated with the similar clusters. In some embodiments, the ML model may assign a value to a document or group of documents relating to a case based on the extracted content data.

In some embodiments, the ML model may output one or more quantitative values indicative of a predicted case outcome. For example, based on certain input content data corresponding to a case, the ML model may output a range of expected outcomes, such as an expected range of case values. As described in further detail below, these values may be used to automatically make decisions, for example, about financing of contingent fee cases. In some embodiments, the ML model may further output a confidence score associated with the predicted outcome and/or case value amount, with a higher confidence score indicating a higher confidence that the predicted outcome and/or case value amount will reflect an actual outcome and/or case value amount. The confidence score may depend on the types of content data available and completeness of the data (e.g., how many data fields of the case record have been populated).

For example, the analytics computing device may be configured to generate and/or display a report based on the output of the ML model. The report may correspond to a single case, or the analytics computing device may identify a group of cases (e.g., cases having certain similar features) and generate an aggregate report corresponding to all of the identified cases. The report may include the predicted case value amount for the one or more cases and/or an aggregate case value amount if the report corresponds to multiple cases. The report may further include additional information about the case and/or cases, such as entities associated with the case and/or cases, confidence scores, missing content data that would improve the evaluation (e.g., confidence score) or value amount of the case and/or cases, and/or documents that may be requested and/or actions that may be taken to obtain such missing content data. The report may be displayed by one or more user computing devices and/or automatically transmitted to certain relevant entities. For example, the report may include a request for financing the case and/or cases and be transmitted to one or more entities that may potentially finance the case and/or cases. In some such embodiments, the analytics computing device may receive responses from such entities and select, or generate and display a recommendation to select, one or more of the entities based on, for example, proposed terms of the financing.

In some embodiments, the analytics computing device may be configured to manage case leads, or potential cases initiated through interaction (e.g., communication) with a potential client. In response to such interaction (e.g., entry of information via webform, social media form, call, and/or email), the analytics computing device may generate a lead (e.g., a data element representing the case lead). In response to generating the lead, the analytics computing device may automatically generate and send communications, such as a welcome email and/or automated phone message, to the potential client. The analytics computing device may gather information (e.g., email address, name, phone number, type of case (e.g., estate planning, criminal, civil, litigation, workers compensation, business service), description of legal case, lead source) based on this communication, for example, by using ML to extract this information from the communication as described above. The analytics computing device may further generate (e.g., using ML) a contract and/or intake packet for sending to the potential client. In some embodiments, the analytics computing device may require user input (e.g., approval by an attorney) before transmitting the contract to the potential client (e.g., via email). The analytics computing device may then parse communications to determine if a signed contract and/or intake packet has been electronically returned, and in response, convert the lead to a case record type (e.g., an electronic record corresponding to a certain category of active case) based on the determination that the intake packet and/or contract has been signed and returned by the potential client and the extracted data indicative of the type of case.

For example, in some embodiments, a certain case record, corresponding to the determined case type, may be generated. The generated case record may be associated with a certain process flow corresponding to the case type. The case record may be, for example, a spreadsheet or database file, and may include a plurality of fields, which may be populated by the analytics computing device based on data extracted from the initial communications with the client and with additional information (e.g., content data) obtained from additional sources (e.g., documents, medical records, and/or correspondence) received by the analytics computing device (e.g., via upload) following the generation of the case record.

In some embodiment, the analytics computing device, using, for example, ML techniques, may identify information (e.g., content data) not currently included in the case record that is necessary and/or helpful for predicting an outcome of the corresponding case. For example, the missing information and/or content data may improve the confidence score of the ML analysis if included as an input, or may increase a case value amount associated with the case. The analytics computing device may identify and/or take steps to obtain this missing information. For example, the analytics computing device may be configured to generate and send correspondence (e.g., emails and/or automated calls) to relevant individuals (e.g., doctors and/or other medical personnel associated with the case) requesting information. The analytics computing device may then receive responses from these individuals and parse the responses (e.g., using ML techniques) to extract the missing information. The extracted information may then be added to the case record. In some embodiments, the analytics computing device may generate tasks or calendar items associated with obtaining the missing information (e.g., tasks or meetings to follow up with individuals, schedule medical tests and/or examinations) for individuals handling the case. For example, if certain medical records are required for a case, the analytics computing device may generate an email or other electronic prompt to the medical provider requesting the medical records and/or generate a task for an attorney handling the case to reach out to the medical provider to request the information. When the information is returned by the medical provider (e.g., via email, a user interface provided by the analytics computing device, and/or other electronic communication), the medical records may be parsed by the analytics computing device to obtain the missing information. In some embodiments, computing systems associated with the medical provider may be configured to automatically retrieve and transmit the missing information to the analytics computing device in response to receiving an electronic request for the information from the analytics computing device.

In some embodiments, the analytics computing device may generate a case value amount for a case by analyzing the content data contained within the case record. The case value amount may be generated by analyzing the content data for the corresponding case record using machine learning techniques as described above. For example, the machine learning model may be trained using a large amount of historical content data and a large number of historical case value amounts (e.g., historical settlement amounts and/or other recovery amounts) associated with the historical content data as training data, such that the machine learning model may be configured to output a case value amount based on input content data for the case. The analytics computing device may be configured to generate correspondence (e.g., an email and/or letter) including the case value amount and transmit the generated correspondence to the client for approval (e.g., as a proposed settlement). If an approval is received by the analytics computing device, the analytics computing device may generate further correspondence (e.g., a proposed settlement letter) and generate tasks for the attorney managing the case to review and/or send the proposed settlement letter.

In some embodiments, as case progresses the analytics computing device may be configured to generate, at least in part, further documents (complaints, discovery documents, and/or depositions), data fields (case number, court judge assigned, opposing counsel), case milestones (e.g., completion of service of process, discovery tasks, and/or depositions), tasks, and/or requests for information. Based on this information, the analytics computing device may extract further content data from provided documents, update the case record, and/or generate additional predictions of case outcomes and/or case value amounts based on the updated content data and/or case record.

In some embodiments, the analytics computing device may be configured to store a plurality of contacts (e.g., clients, doctors, experts, and/or attorneys) associated with a particular case. Data stored in association with such contacts may include, for example, name, date of birth, social security number, address, email, telephone number, website, practice area, previous cases, and/or coordinator associated with the individual. In some such embodiments, the particular data fields associated with a particular contact may depend on the type of contact. For example, a “practice area” and/or “previous cases” field may be included to an attorney, doctor, and/or expert, but not necessarily for a client. In some embodiments, these data fields may be populated by the analytics computing device, for example, by parsing correspondence and/or other documents using ML techniques, as described above. The contacts associated with a particular case may be stored in association with the case record corresponding to that case.

In some embodiments, the case record may include, or be stored in association with, certain types of documents and/or data corresponding to the associated case. For example, the case record may include documents and/or data relating to correspondence, settlement and trust accounting, pleadings and/or other prepared legal work, case expenses, potential evidence, and/or medical records. As described above, the analytics computing device may be configured to extract text from such documents (e.g., using OCR and/or ML techniques) to populate various data fields of the case record. The analytics computing device may use this populated data in turn to generate predictions of case outcomes, as described above.

In some embodiments, the analytics computing device is configured to implement a call “bot” mechanism (e.g., a chatbot or voice bot), in which the analytics computing device may extract information from incoming telephone calls and/or generate automated responses to the calls. For example, when an incoming call is detected, the analytics computing device may determine an identity and/or type of the caller such as, for example, an existing and/or new client, a medical provider, an attorney, an insurance company, and/or someone else. If the caller is a new client, the analytics computing device may obtain (e.g., by prompting the caller via a recorded message and recording the response) the caller's name, case description, and/or contact information, and may transfer the call to a relevant individual. If the caller is an insurance company and/or an opposing attorney, in a similar manner, the analytics computing device may obtain an identity of the calling entity (e.g., an insurance company and/or attorney), their client, and/or a purpose of the call. If the caller is an existing client, the analytics computing device may obtain a name of the client and/or a purpose of the call. If the caller is a medical provider, the analytics computing device may obtain an identity of the case, the corresponding patient, and/or a purpose of the call. In any case, the analytics computing device may record the call and store the recorded call in the corresponding case record, and may extract information and/or content data from the recorded call as described above. The analytics device may further generate automatic responses to the calls, such as an indication that a representative will follow up on the call, instructions to access a relevant web portal, or transfer to a relevant representative. In some embodiments, AI techniques may be used to implement these call bots. For example, the call bots may utilize ChatGPT and/or other AI chatbot algorithms to interpret inputs submitted by users and generate responses to these inputs.

At least one of the technical problems addressed by this system may include: (i) inability of a computing device to extract content data from documents with a semantic analysis engine using character recognition and other scanning techniques; (ii) inability of a computing device to utilize machine learning techniques to generate predictions about a case outcome based on content data; (iii) inability of a computing device to utilize machine learning techniques to predict a case value based on content data; (iv) inability of a computing device to electronically extract content data from telephone calls; (v) inability of a computing device to use machine learning techniques to identify information to request and generate requests for information based on content data extracted using character recognition and other scanning techniques; (vi) inability of computing device to use input data including documents having various different data formats as inputs for a machine learning model; and/or (vii) inability of a computing device to generate an instantaneous case value amount based on content data by analyzing currently available content data using machine learning techniques.

A technical effect of the systems and processes described herein may be achieved by performing at least one of the following steps: (i) storing a plurality of documents in association with a case identifier; (ii) electronically extracting content data from the plurality of documents using a semantic analysis engine; (iii) generating a case record in the memory including the extracted content data associated with the case identifier, the case record having a predefined data format; (iv) executing a machine learning model configured to output a predicted value amount by inputting at least a portion of the extracted content data included in the case record, the machine learning model trained using a plurality of historical case records and a plurality of historical value amounts associated with the historical case records; and/or (v) causing the predicted value amount outputted by the machine learning model to be displayed.

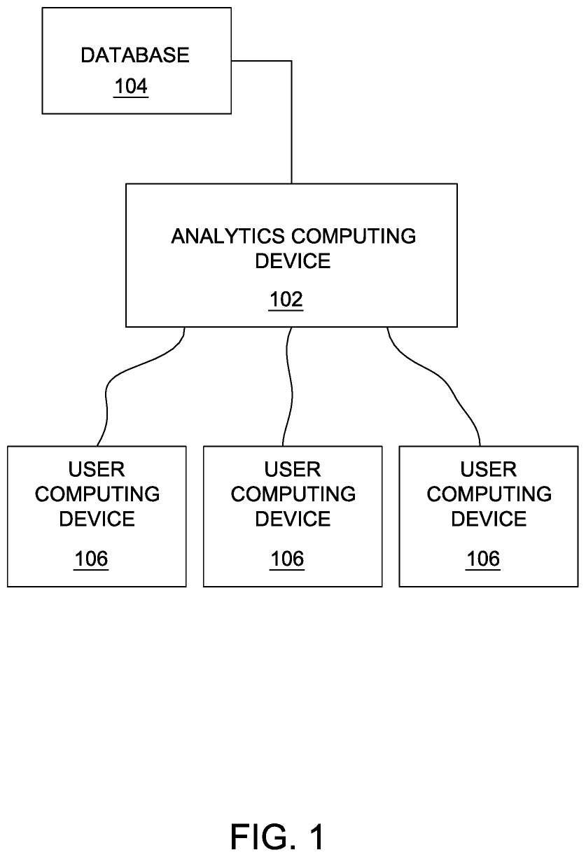

FIG. 1 depicts an example analytics system 100. Analytics system 100 may include an analytics computing device 102 in communication with a database 104. Analytics computing device 102 may further be in communication with one or more user computing devices 106. User computing devices 106 may be, for example, personal computers, tablets, mobile phone device, or other computing devices capable of communicating with analytics computing device 102.

In some embodiments, some embodiments, analytics computing device 102 is configured to cause the one or more user computing devices 106 to display a user interface though which users (e.g., attorneys and/or staff handling a case) may interact with analytics computing device 102. Database 104 may be configured to store documents and/or data (e.g., content data) extracted therefrom, as described in further detail below.

In the example embodiment, analytics computing device 102 may be configured to receive documents and store the received documents in the database. As described below, the documents may be submitted electronically (e.g., via scanning or transmitting via a connected computer), and may be analyzed using OCR, natural word analysis, sentiment analysis, image recognition, or other computer-executable analytic processes that may make determinations about contents of the received documents. Analytics computing device 102 may identify documents relating to a particular case and store the documents in association with each other and a corresponding case file. These documents may include, for example, documents (e.g., written statements made by witnesses), records (e.g., medical, police, and/or insurance records), images, audio and/or video records, electronic communication (e.g., emails and/or text messages), and/or other types of documents that may be stored electronically at least to an extent. The documents may be received, for example, by being uploaded by a user (e.g., though a web-based and/or application-based portal), by retrieving and/or scraping data from telephone calls, emails, and/or other electronic correspondence, and/or by querying external databases.

Because the documents may be stored in any of a variety of different file types and/or formats, the processor may be configured to extract content data from these documents and store the extracted content data in a specific data format. For example, in some embodiments, the processor may be configured to apply OCR programs to documents such as portable document format (PDF) files (e.g., scans of documents) to extract text data from the documents, and to run a specified machine learning flow (e.g., depending on the document type) to extract content data from the text. For example, when analyzing medical records, the machine learning flow may utilize a medical ontology vocabulary, which semantically defines terms that may be found within the text, to parse the text data for medical information. In other words, certain terms or combinations of terms within the text may be identified as corresponding to certain medical information, and this medical information may then be stored as content data in a predefined format. In some embodiments, in addition to documents, the processor may be configured to generate text data from audio sources (e.g., recorded telephone calls and/or other statements) using, for example, speech-to-text programs, and process the text data using the machine learning flow as described above to generate content data. Such data may additionally be used as training data, which the processor may use to continually refine the machine learning model that extracts data from the documents.

In the example embodiment, once the content data has been extracted from the documents and stored in the database, the processor may configured to develop a model that links the occurrence of certain extracted content data with case outcomes (e.g., a settlement and/or value received amount). For example, the extracted content data and historical case outcomes may be used as training data to train an ML model, and the ML model may then be used to predict future case outcomes based on content data corresponding to current cases utilizing correlations identified between the occurrence of certain content data and certain case outcomes. The ML model may include clusters of similar patterns of content data, and upon receiving input content data, compare the input content data to the clusters to identify similar clusters and generate predictions based on historical outcomes associated with the similar clusters. In some embodiments, the ML model may assign a value to a document or group of documents relating to a case based on the extracted content data.

In some embodiments, the ML model may output one or more quantitative values indicative of a predicted case outcome. For example, based on certain input content data corresponding to a case, the ML model may output a range of expected outcomes, such as an expected range of case values. As described in further detail below, these values may be used to automatically make decisions about for example, about financing of contingent fee cases.

For example, analytics computing device 102 may be configured to generate and/or display a report based on the output of the ML model. The report may correspond to a single case, or the analytics computing device may identify a group of cases (e.g., cases having certain similar features) and generate an aggregate report corresponding to all of the identified cases. The report may include the predicted case value amount for the one or more cases and/or an aggregate case value amount if the report corresponds to multiple cases. The report may further include additional information about the case and/or cases, such as entities associated with the case and/or cases, missing content data that would improve the evaluation (e.g., confidence score) or value amount of the case and/or cases, and/or documents that may be requested and/or actions that may be taken to obtain such missing content data. The report may be displayed by one or more user computing devices 106 and/or automatically transmitted to certain relevant entities. For example, the report may include a request for financing the case and/or cases and be transmitted to one or more entities that may potentially finance the case and/or cases. In some such embodiments, analytics computing device 102 may receive responses from such entities and select, or generate and display a recommendation to select, one or more of the entities based on, for example, proposed terms of the financing.

In some embodiments, analytics computing device 102 may be configured to manage case leads, or potential cases initiated through interaction (e.g., communication) with a potential client. In response to such interaction (e.g., entry of information via webform, social media form, call, and/or email), analytics computing device 102 may generate a lead (e.g., a data element representing the case lead). In response to generating the lead, analytics computing device 102 may automatically generate and send communications, such as a welcome email and/or automated phone message, to the potential client. Analytics computing device 102 may gather information (e.g., email address, name, phone number, type of case (e.g., estate planning, criminal, civil, litigation, workers compensation, business service), description of legal case, lead source) based on this communication, for example, by using ML to extract this information from the communication as described above. Analytics computing device 102 may further generate (e.g., using ML) a contract and/or intake packet for sending to the potential client. In some embodiments, analytics computing device 102 may require user input (e.g., approval by an attorney) before transmitting the contract to the potential client (e.g., via email). Analytics computing device 102 may then parse communications to determine if a signed contract and/or intake packet has been electronically returned, and in response, convert the lead to a case record type (e.g., an electronic record corresponding to a certain category of active case) based on the determination that the intake packet and/or contract has been signed and returned by the potential client and the extracted data indicative of the type of case.

For example, in some embodiments, a certain case record, corresponding to the determined case type, may be generated. The generated case record may be associated with a certain process flow corresponding to the case type. The case record may be, for example, a spreadsheet or database file, and may include a plurality of fields, which may be populated by analytics computing device 102 based on data extracted from the initial communications with the client and with additional information (e.g., content data) obtained from additional sources (e.g., documents, medical records, and/or correspondence) received by analytics computing device 102 (e.g., via upload) following the generation of the case record.

In some embodiment, analytics computing device 102, using, for example, ML techniques, may identify information (e.g., content data) not currently included in the case record that is necessary and/or helpful for predicting an outcome of the corresponding case. Analytics computing device 102 may identify and/or take steps to obtain this missing information. For example, analytics computing device 102 may be configured to generate and send correspondence (e.g., emails and/or automated calls) to relevant individuals (e.g., doctors and/or other medical personnel associated with the case) requesting information. Analytics computing device 102 may then receive responses from these individuals and parse the responses (e.g., using ML techniques) to extract the missing information. The extracted information may then be added to the case record. In some embodiments, analytics computing device 102 may generate tasks or calendar items associated with obtaining the missing information (e.g., tasks or meetings to follow up with individuals, schedule medical tests and/or examinations) for individuals handling the case. For example, if certain medical records are required for a case, analytics computing device 102 may generate an email to the medical provider requesting the medical records and/or generate a task for an attorney handling the case to reach out to the medical provider to request the information. When the information is returned by the medical provider (e.g., via email and/or other electronic communication), the medical records may be parsed by analytics computing device 102 to obtain the missing information. In some embodiments, computing systems associated with the medical provider may be configured to automatically retrieve and transmit the missing information to analytics computing device 102 in response to receiving an electronic request for the information from analytics computing device 102.

In some embodiments, analytics computing device 102 may generate a case value amount for a case by analyzing the content data contained within the case record. The case value amount may be generated by analyzing the content data for the corresponding case record using machine learning techniques as described above. For example, the machine learning model may be trained using a large amount of historical content data and a large number of historical case value amounts (e.g., historical settlement amounts and/or other recovery amounts) associated with the historical content data as training data, such that the machine learning model may be configured to output a case value amount based on input content data for the case. Analytics computing device 102 may be configured to generate correspondence (e.g., an email and/or letter) including the case value amount and transmit the generated correspondence to the client for approval (e.g., as a proposed settlement). If an approval is received by analytics computing device 102, analytics computing device 102 may generate further correspondence (e.g., a proposed settlement letter) and generate tasks for the attorney managing the case to review and/or send the proposed settlement letter.

In some embodiments, as case progresses analytics computing device 102 may be configured to generate, at least in part, further documents (complaints, discovery documents, and/or depositions), data fields (case number, court judge assigned, opposing counsel), case milestones (e.g., completion of service of process, discovery tasks, and/or depositions), tasks, and/or requests for information. Based on this information, analytics computing device 102 may extract further content data from provided documents, update the case record, and/or generate additional predictions of case outcomes and/or case value amounts based on the updated content data and/or case record.

In some embodiments, analytics computing device 102 may be configured to store a plurality of contacts (e.g., clients, doctors, experts, and/or attorneys) associated with a particular case. Data stored in association with such contacts may include, for example, name, date of birth, social security number, address, email, telephone number, website, practice area, previous cases, and/or coordinator associated with the individual. In some such embodiments, the particular data fields associated with a particular contact may depend on the type of contact. For example, a “practice area” and/or “previous cases” field may be included to an attorney, doctor, and/or expert, but not necessarily for a client. In some embodiments, these data fields may be populated by analytics computing device 102, for example, by parsing correspondence and/or other documents using ML techniques, as described above. The contacts associated with a particular case may be stored in association with the case record corresponding to that case.

In some embodiments, the case record may include, or be stored in association with, certain types of documents and/or data corresponding to the associated case. For example, the case record may include documents and/or data relating to correspondence, settlement and trust accounting, pleadings and/or other prepared legal work, case expenses, documents, and/or medical records. As described above, analytics computing device 102 may be configured to extract text from such documents (e.g., using OCR and/or ML techniques) to populate various data fields of the case record. Analytics computing device 102 may use this populated data in turn to generate predictions of case outcomes, as described above.

In some embodiments, analytics computing device 102 is configured to implement a call “bot” mechanism, in which analytics computing device 102 may extract information from incoming telephone calls and/or generate automated responses to the calls. For example, when an incoming call is detected, analytics computing device 102 may determine an identity and/or type of the caller such as, for example, an existing and/or new client, a medical provider, an attorney, an insurance company, and/or someone else. If the caller is a new client, analytics computing device 102 may obtain (e.g., by prompting the caller via a recorded message and recording the response) the caller's name, case description, and/or contact information, and may transfer the call to a relevant individual. If the caller is an insurance company and/or an opposing attorney, in a similar manner, analytics computing device 102 may obtain an identity of the calling entity (e.g., an insurance company and/or attorney), their client, and/or a purpose of the call. If the caller is an existing client, analytics computing device 102 may obtain a name of the client and/or a purpose of the call. If the caller is a medical provider, analytics computing device 102 may obtain an identity of the case, the corresponding patient, and/or a purpose of the call. In any case, analytics computing device 102 may record the call and store the recorded call in the corresponding case record, and may extract information and/or content data from the recorded call as described above. The analytics device may further generate automatic responses to the calls, such as an indication that a representative will follow up on the call, instructions to access a relevant web portal, or transfer to a relevant representative. In some embodiments, AI techniques may be used to implement these call bots. For example, the call bots may utilize ChatGPT and/or other AI chatbot algorithms to interpret inputs submitted by users and generate responses to these inputs.

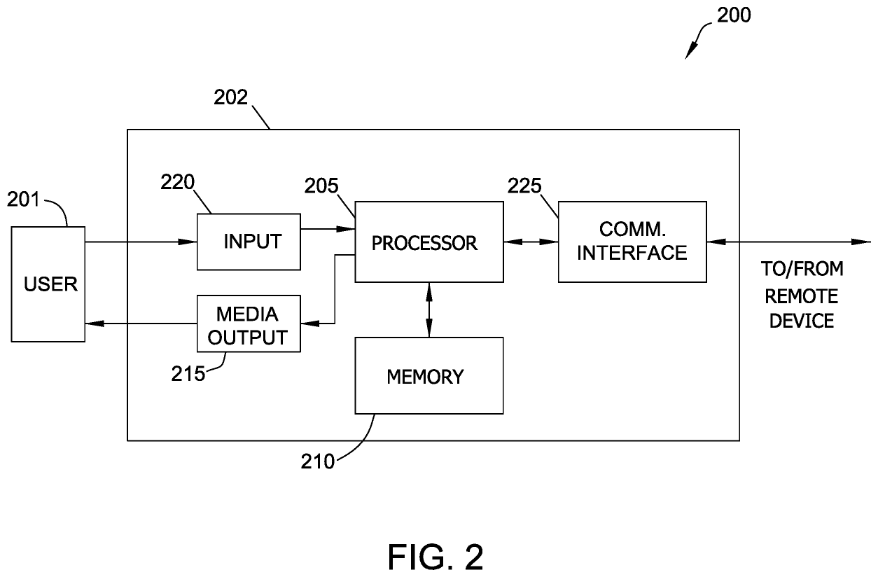

FIG. 2 depicts an example client computing device 202. Client computing device 202 may be, for example, at least one of user computing devices 106 (shown in FIG. 1).

Client computing device 202 may include a processor 205 for executing instructions. In some embodiments, executable instructions may be stored in a memory area 210. Processor 205 may include one or more processing units (e.g., in a multi-core configuration). Memory area 210 may be any device allowing information such as executable instructions and/or other data to be stored and retrieved. Memory area 210 may include one or more computer readable media.

In example embodiments, client computing device 202 may also include at least one media output component 215 for presenting information to a user 201. Media output component 215 may be any component capable of conveying information to user 201. In some embodiments, media output component 215 may include an output adapter such as a video adapter and/or an audio adapter. An output adapter may be operatively coupled to processor 205 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 202 may also include an input device 220 for receiving input from user 201. Input device 220 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 215 and input device 220.

Client computing device 202 may also include a communication interface 225, which can be communicatively coupled to a remote device such as analytics computing device 102 (shown in FIG. 1). Communication interface 225 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 210 may be, for example, computer readable instructions for providing a user interface to user 201 via media output component 215 and, optionally, receiving and processing input from input device 220. A user interface may include, among other possibilities, a web browser and client application. Web browsers may enable users, such as user 201, to display and interact with media and other information typically embedded on a web page or a website. A client application may allow user 201 to interact with a server application from analytics computing device 102 (shown in FIG. 1).

Memory area 210 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

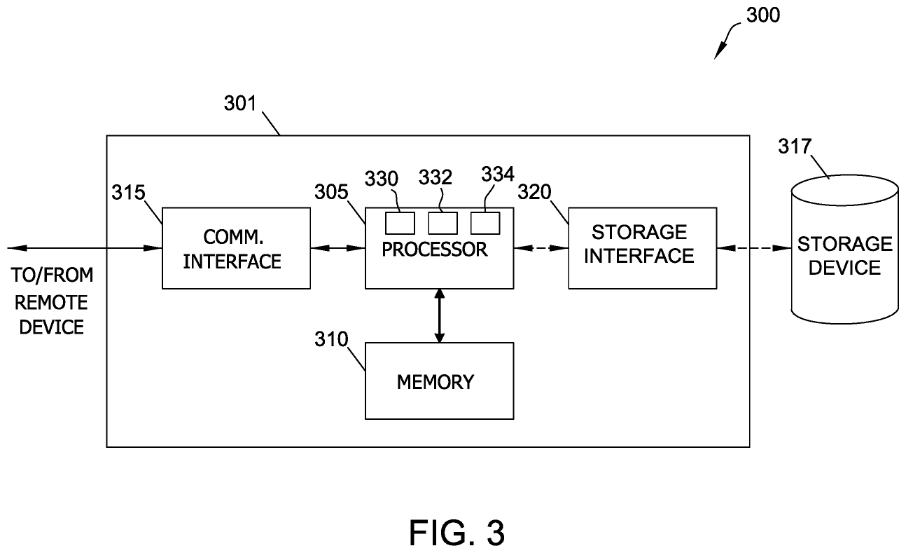

FIG. 3 depicts an example server system that may be used with analytics system 100 illustrated in FIG. 1. Server system 301 may be, for example, analytics computing device 102 (shown in FIG. 1).

In example embodiments, server system 301 may include a processor 305 for executing instructions. Instructions may be stored in a memory area 310. Processor 305 may include one or more processing units (e.g., in a multi-core configuration) for executing instructions. The instructions may be executed within a variety of different operating systems on server system 301, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

In example embodiments, processor 305 may include and/or be communicatively coupled to one or more modules for implementing the systems and methods described herein. Processor 305 may include a data management module 330 configured to store, in a database (e.g., database 104), a plurality of documents relating to a case, and store extracted content data in the database. Processor 305 may further include a language processing module 332 configured to extract content data from the plurality of documents using a semantic analysis engine. Processor 305 may further include a prediction module 334 configured to generate at least one prediction relating to an outcome of the case including, for example, a predicted case value amount.

Processor 305 may be operatively coupled to a communication interface 315 such that server system 301 is capable of communicating with user computing devices 106 (shown in FIG. 1), or another server system 301. For example, communication interface 315 may receive requests from user computing device 106 via the Internet.

Processor 305 may also be operatively coupled to a storage device 317, such as database 104 (shown in FIG. 1). Storage device 317 may be any computer-operated hardware suitable for storing and/or retrieving data. In some embodiments, storage device 317 may be integrated in server system 301. For example, server system 301 may include one or more hard disk drives as storage device 317.

In other embodiments, storage device 317 may be external to server system 301 and may be accessed by a plurality of server systems 301. For example, storage device 317 may include multiple storage units such as hard disks or solid state disks in a redundant array of inexpensive disks (RAID) configuration. Storage device 317 may include a storage area network (SAN) and/or a network attached storage (NAS) system.

In some embodiments, processor 305 may be operatively coupled to storage device 317 via a storage interface 320. Storage interface 320 may be any component capable of providing processor 305 with access to storage device 317. Storage interface 320 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 305 with access to storage device 317.

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

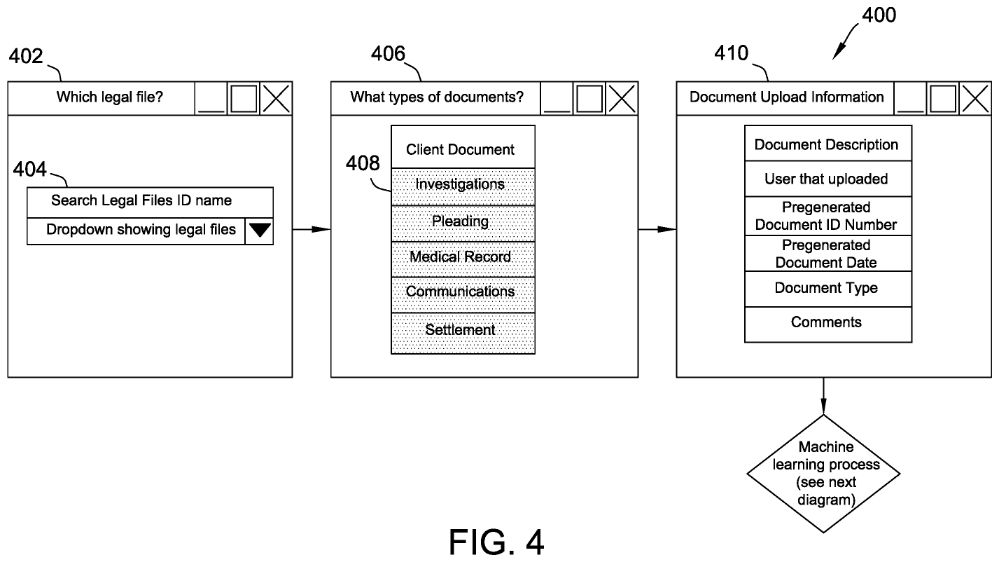

FIG. 4 is a flow diagram representing an example process 400 for inputting a document into analytics system 100. Process 400 may be implemented by displaying a user interface at a display of one of user computing devices 106, with which a user may interact to input the document. Process 400 may include selecting 402 a document (e.g., a digital document file such as a PDF) for input into analytics system 100, for example, by entering a document name at a document field 404 of the user interface. Process 400 may further include categorizing 406 the document according to type (e.g., investigations, pleading, medical record, communication, and/or settlement). In some embodiments, a user may select the document type by selecting from a dropdown list 408 displayed via the user interface. Process 400 may further include compiling and/or generating 410 information regarding the document (e.g., document description, user that uploaded, document ID number, document date, document type, and/or comments), which may be information automatically generated by analytics system 100 (e.g., using analytics computing device 102 and/or user computing device 106) or entered by a user. The document and associated information may be stored by analytics computing device 102, for example, in database 104.

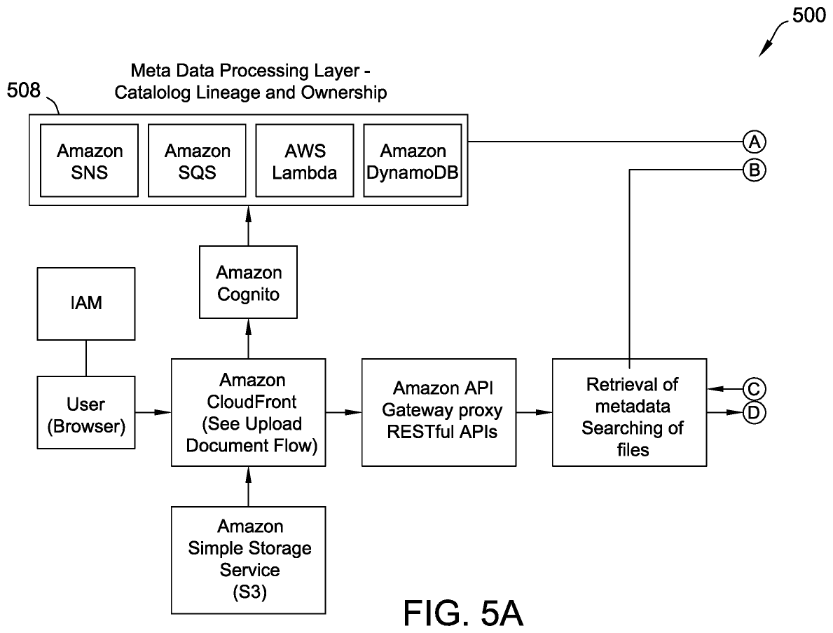

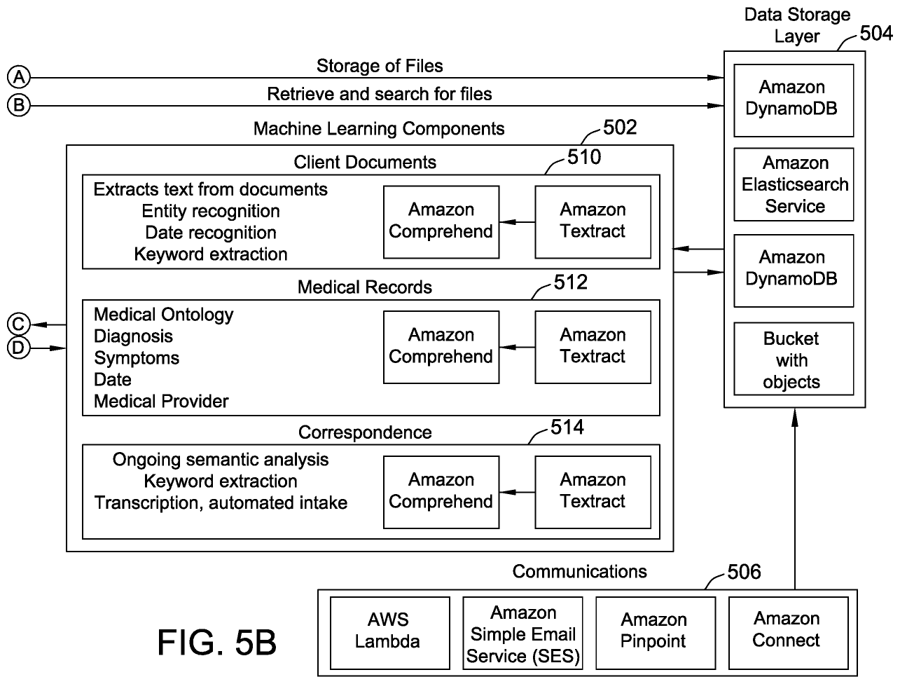

FIGS. 5A and 5B depict an example machine learning system 500 that may be implemented using analytics system 100. Machine learning system 500 includes a machine learning component 502, a data storage layer 504, a communications layer 506, and a metadata processing layer 508.

Machine learning component 502 may include a client documents module 510, a medical records module 512, and/or a correspondence module 514. Client documents module 510 may be configured to extract content data from documents, for example, by using OCR to extract text data and interpreting the text data using ML techniques to generate content data. Similarly, medical records module 512 may be configured to generate content data based on a ML analysis of medical records, and correspondence module 514 may be configured generate content data based on a ML analysis of correspondence (e.g., letters, emails and/or telephone calls).

Data storage layer 504 may be configured to store input files such as documents, medical records, and correspondence, and to store content data generated by machine learning component 502. Machine learning component 502 may be coupled in communication with data storage layer 504, and may perform ML operations on files stored by data storage layer 504 to generate content data, and perform ML operations on content data, for example, to generate predictions for case outcomes, as described above with respect to FIG. 1. Communications layer 506 may be configured to retrieve electronic correspondence (e.g., letters, emails and/or telephone calls) from respective communication channels, which may then be stored by data storage layer 504. Metadata processing layer 508 may be configured to enable a user (e.g., by user input through a user interface) to categorize documents, as described above with respect to FIG. 4.

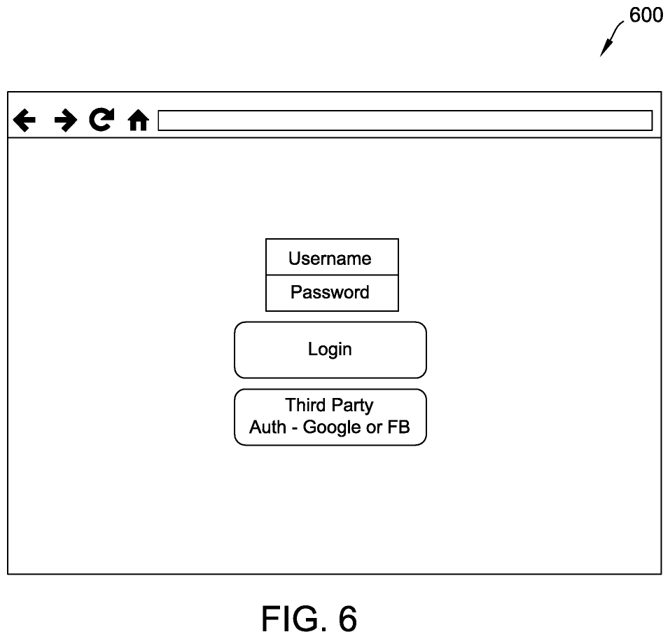

FIG. 6 depicts a screenshot 600 of an example login screen for a file management application, which may be displayed, for example, by one of user computing devices 106 and may enable a user to input login information to access the functions of analytics system 100.

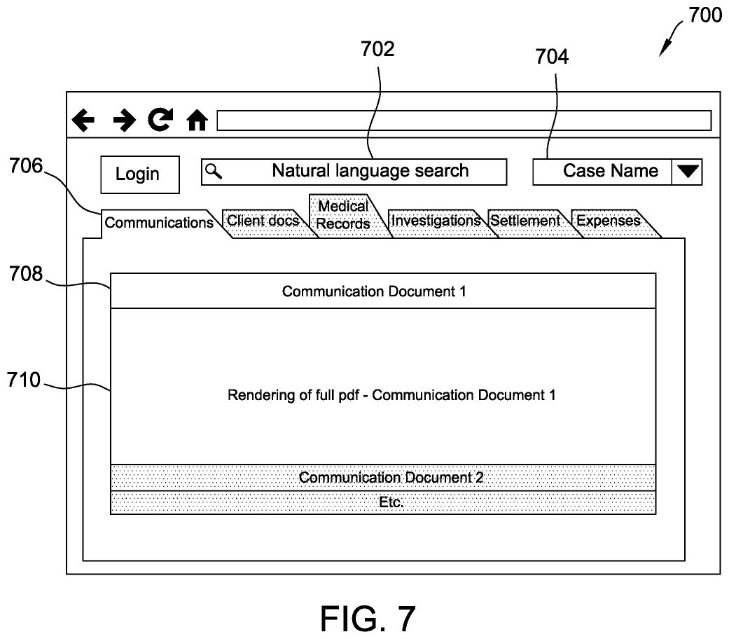

FIG. 7 depicts another screenshot 700 of the file management application, which may be displayed, for example, by one of user computing devices 106. The file management application includes a search bar 702, which may be used to search for documents stored in, for example, database 104. Search results may be retrieved using a search algorithm such as a natural language search. The fila management application may further include a case name field 704, with which a user may select a certain case. In some embodiments, when a search is executed via search bar 702, the search results may be limited to documents relating to the case selected via case name field 704. The file management application may further include one or more tabs 706, which may be used to select a certain category of documents for display (e.g., communications, client documents, medical records, investigations, settlement, and/or expenses. The file management application may further include a list 708 that displays names of and/or other information relating to documents in the selected category. In some embodiments, when selected by a user, for example, by clicking on or hovering a cursor over a certain document name, a preview 710 (e.g., a rendering or full PDF) of the document may be displayed.

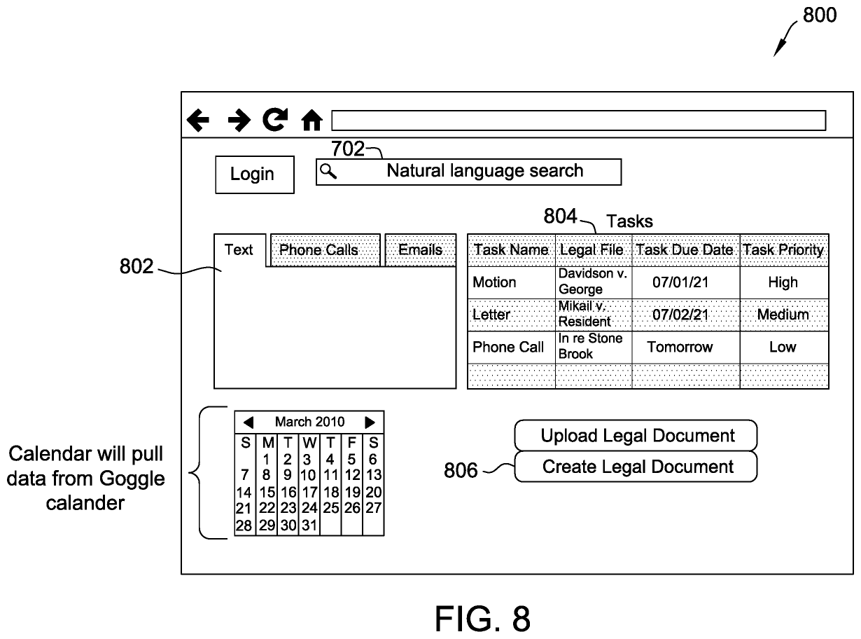

FIG. 8 depicts another screenshot 800 of the file management application, which may be displayed, for example, by one of user computing devices 106. The file management application may further include a communications viewer 802, which may enable a user to select and view communications related to a case (e.g., text, telephone calls, and emails). The file management application may further include a task viewer 804, which may enable a user to select and view tasks related to a case. These tasks may be automatically generated by analytics computing device 102, as described above. The management application may further click buttons 806, which may be used to call up functions (e.g., process 400 described in FIG. 4) for uploading or creating legal documents within the user interface. Documents uploaded using the file management application may be stored in database 104.

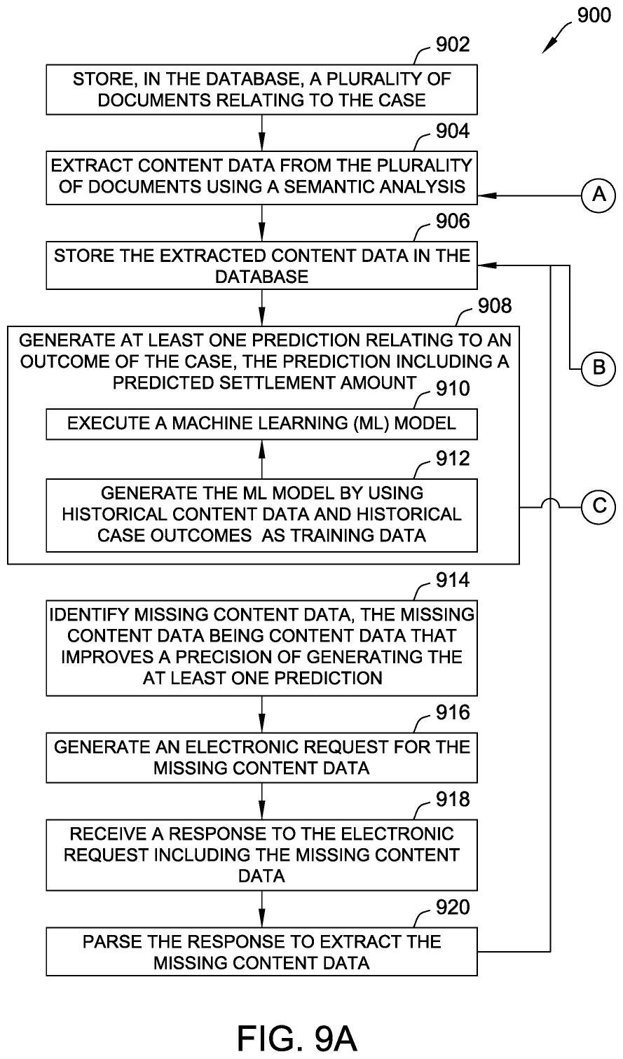

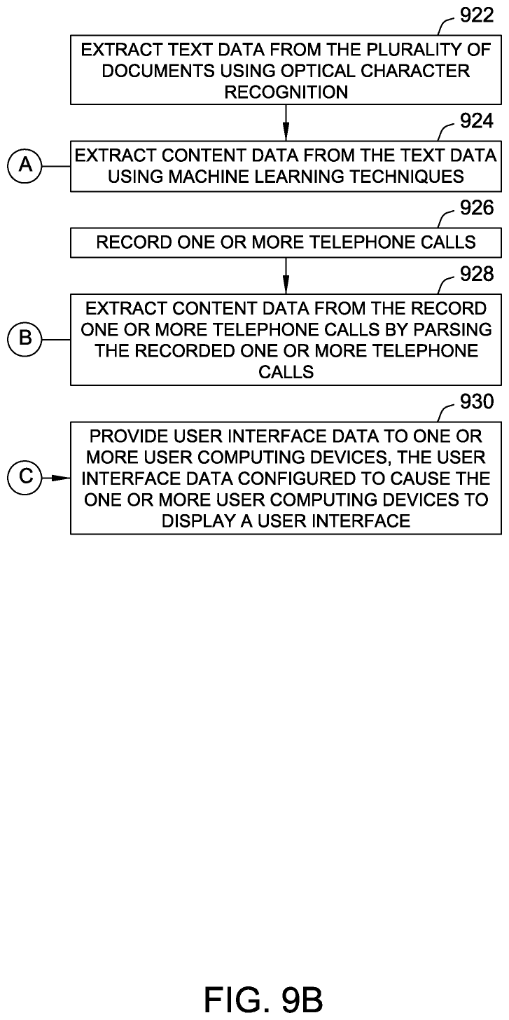

FIGS. 9A and 9B depicts an example computer-implemented method 900. Computer-implemented method 900 may be performed, for example, by analytics system 100 including analytics computing device 102 and database 104 (all shown in FIG. 1).

Computer-implemented method 900 may include storing 902, in the database, a plurality of documents relating to a case. In some embodiments, storing 902 the plurality of documents may be performed by analytics computing device 102, for example, by executing data management module 330 (shown in FIG. 3).

Computer-implemented method 900 may further include extracting 904 content data from the plurality of documents using a semantic analysis. In some embodiments, extracting 904 the content data may be performed by analytics computing device 102, for example, by executing language processing module 332 (shown in FIG. 3).

Computer-implemented method 900 may further include storing 906 the extracted content data in the database. In some embodiments, storing 906 the extracted content data may be performed by analytics computing device 102, for example, by executing data management module 330 (shown in FIG. 3).

Computer-implemented method 900 may further include generating 908 at least one prediction relating to an outcome of the case, the prediction including a predicted case value. In some embodiments, generating 908 the prediction may be performed by analytics computing device 102, for example, by executing prediction module 334 (shown in FIG. 3).

In some embodiments, generating 908 the at least one prediction may include executing 910 an ML model. In some such embodiments, computer-implemented method 900 may further include generating 912 the ML model by using historical content data and historical case outcomes as training data.

In some embodiments, computer-implemented method 900 may further include identifying 914 missing content data, which may be content data that improves a precision of generating the at least one prediction (e.g., gives a more precise case value amount and/or range). In some such embodiments, computer-implemented method 900 may further include generating 916 an electronic request for the missing content data, receiving 918 a response to the electronic request including the missing content data, and parsing 920 the response to extract the missing content data.

In some embodiments, computer-implemented method 900 may further include extracting 922 text data from the plurality of documents using optical character recognition. In some such embodiments, computer-implemented method 900 may further include extracting 924 content data from the text data using machine learning techniques.

In some embodiments, computer-implemented method 900 may further include recording 926 one or more telephone calls and extracting 928 content data from the recorded one or more telephone calls by parsing the recorded one or more telephone call.

In some embodiments, computer-implemented method 900 may further include providing 930 user interface data to one or more user computing devices, the user interface data configured to cause the one or more user computing devices to display a user interface. In some such embodiments, the user interface may be configured to display the at least one prediction relating to the outcome of the case. In some such embodiments, the user interface may be configured to prompt a user to upload at least one of the plurality of documents. In some such embodiments, the user interface may be configured to display at least one of the plurality of documents.

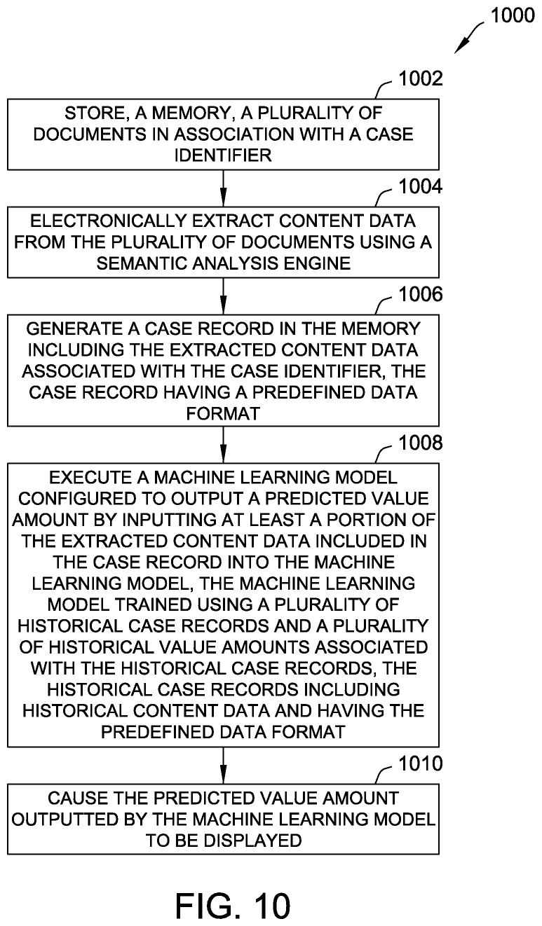

FIG. 10 depicts an example computer-implemented method 1000. Computer-implemented method 1000 may be performed, for example, by analytics system 100 including analytics computing device 102 and database 104 (all shown in FIG. 1).

Computer-implemented method 1000 may include storing 1002 a plurality of documents in association with a case identifier. In some embodiments, storing 1002 the plurality of documents may be performed by analytics computing device 102, for example, by executing data management module 330 (shown in FIG. 3).

Computer-implemented method 1000 may further include electronically extracting 1004 content data from the plurality of documents using a semantic analysis engine. In some embodiments, electronically extracting 1004 the content data may be performed by analytics computing device 102, for example, by executing language processing module 332 (shown in FIG. 3).

Computer-implemented method 1000 may further include generating 1006 a case record including the extracted content data associated with the case identifier. The case record having a predefined data format. In some embodiments, generating 1006 the case record may be performed by analytics computing device 102, for example, by executing data management module 330 (shown in FIG. 3).

Computer-implemented method 1000 may further include executing 1008 a machine learning model configured to output a predicted value amount by inputting at least a portion of the extracted content data included in the case record into the machine learning model. The machine learning model may be trained using a plurality of historical case records and a plurality of historical value amounts associated with the historical case records. The historical case records may include historical content data and have the predefined data format. In some embodiments, executing 1008 the machine learning model may be performed by analytics computing device 102, for example, by executing prediction module 334 (shown in FIG. 3).

Computer-implemented method 1000 may further include causing 1010 the predicted value amount outputted by the machine learning model to be displayed. In some embodiments, causing 1010 the predicted value amount to be displayed may be performed by analytics computing device 102, for example, by providing user interface data to one of user computing devices 106.

In some embodiments, backpropagation may be used for training artificial neural networks. Backpropagation includes computing a gradient of a loss function with respect to each weight in the neural network, and then adjusting the weights in the direction of the negative gradient to minimize the loss function.

The backpropagation algorithm can be broken down into the following steps:

Forward Pass: In this step, the input data is fed into the neural network, and the output is computed by propagating the activations forward through the layers of the network. This can be represented mathematically as:

z^{(l)}=W^{(l)}a^{(l-1)}+b^{(l)}

a^{(l)}=g(z^{(l)})

where z^{(l)} represents the pre-activation values for layer l, W^{(l)} and b^{(l)} represent the weights and biases for layer l, a^{(l-1)} represents the activation values for the previous layer, and g is the activation function.

Backward Pass: In this step, the error is propagated backwards through the network, and the gradient of the loss function with respect to each weight is computed using the chain rule. This can be represented mathematically as:

δ^{(L)}=∇ₐJ⊙g′(z^{(L)})

δ^{(l)}=(W^{(l+1)})^{T}δ^{(l+1)}⊙g′(z^{(l)})

where δ^{(l)} represents the error for layer l, J represents the loss function, and ⊙ represents the element-wise multiplication.

Weight Update: In this step, the weights are adjusted in the direction of the negative gradient to minimize the loss function. This can be represented mathematically as:

W^{(l)}=W^{(l)}−αδ^{(l)}(a^{(l-1)})^{T}

b^{(l)}=b^{(l)}−αδ^{(l)}

where α represents the learning rate.

By iteratively repeating these steps for a set number of epochs or until convergence is achieved, the neural network can be trained to accurately predict outputs for new inputs.

Activation functions may be used by artificial neural networks to introduce non-linearity to the model. The activation function takes in the weighted sum of the input values and biases and transforms the input into a non-linear output value that is then passed to the next layer of the network. There are several popular activation functions used in neural networks such as sigmoid, ReLU (Rectified Linear Unit), and tanh (hyperbolic tangent). The sigmoid function is commonly used in binary classification tasks as it maps any input value to a range of 0 to 1. The sigmoid can be represented mathematically as:

$$σ ( z ) = \frac{1}{1 + {e}^{- z}}$$

The ReLU function may be used in deep learning models as it is computationally efficient. The ReLU function maps any input value less than 0 to 0 and any value greater than 0 to itself. It can be represented mathematically as:

ƒ(z)=max(0,z)

The tanh function is similar to the sigmoid function but maps the input to a range of −1 to 1. The tanh function may be used in image processing tasks as it can handle negative inputs. It can be represented mathematically as:

$$tanh ( z ) = \frac{{e}^{z} - {e}^{- z}}{{e}^{z} + {e}^{- z}}$$

The choice of activation function can have a significant impact on the performance of the neural network, and it is important to experiment with different functions to find the most suitable one for the task at hand.

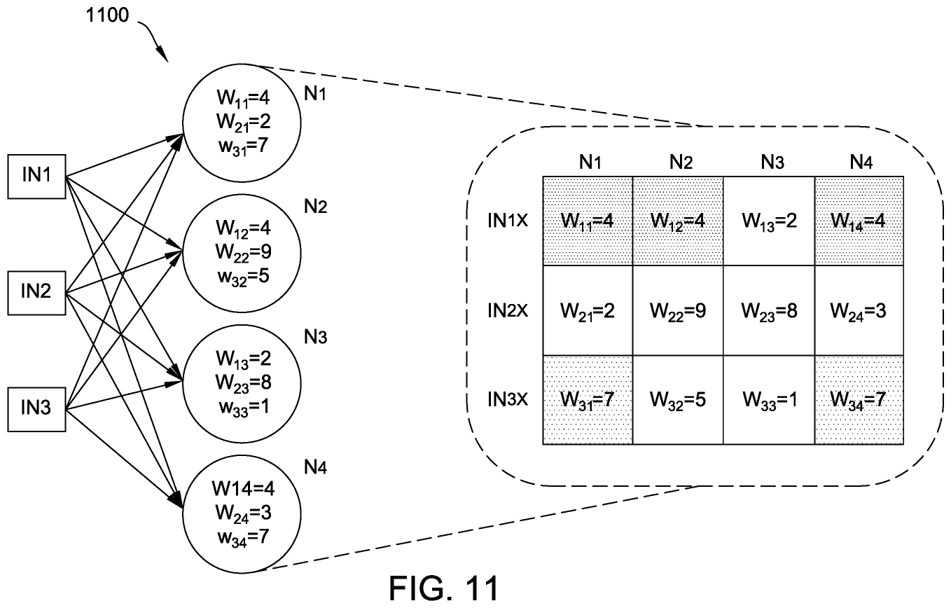

FIG. 11 is an example neural network architecture 1100 that may be used by analytics system 100 (shown in FIG. 1).

Neural network architecture 1100 may include an input layer, one or more hidden layers, and an output layer. Each layer may contain one or more neurons that are connected to neurons in the adjacent layers via edges. The input layer may receive the input variables, which may be processed through the hidden layers before being output as the final result.

Mathematically, a neural network with n input variables and a single output variable may be represented as follows:
Given input variables x∈Rⁿ, hidden layer weights w^{(h)}∈R^{n×h}, hidden layer biases b^{(h)}∈R^{h}, output layer weights w^{(o)}∈ [symbol] , and output layer bias b^{(o)}∈R, the output value y is given by:

y=ƒ(w^{(o)Ta}^{^{(h)}}+b^{(o)})

where a^{(h)} is the activation value of the hidden layer and is computed as:

a^{(h)}=ƒ(w^{(h)Tx}+b^{(h)})

Here, ƒ is the activation function used for the hidden and output layers. The neural network may be trained by adjusting the weights and biases through backpropagation to minimize the loss function.

In predicting a case value amount, a choice of loss function may provide a measure of how well the neural network is performing in terms of its output compared to the expected output. An example loss function for regression problems is mean squared error (MSE), which is defined as:

$$M S E = \frac{1}{n} {\sum }_{i = 1}^{n} {( {y}_{i} - {\hat{y}}_{l} )}^{2}$$

where yᵢ is the expected value of the legal case and ŷᵢ is the predicted value for the ith data point. Another example loss function for regression problems is mean absolute error (MAE), which is defined as:

$$M A E = \frac{1}{n} {\sum }_{i = 1}^{n} \vert {y}_{i} - {\hat{y}}_{l} \vert$$

where yᵢ is the expected value of the legal case and ŷᵢ is the predicted value for the ith data point.

For binary classification problems, an example loss function is binary cross-entropy (BCE), which is defined as:

$$B C E = - \frac{1}{n} {\sum }_{i = 1}^{n} ( {y}_{i} log ( {\hat{y}}_{l} ) + ( 1 - {y}_{i} ) log ( 1 - {\hat{y}}_{l} ) )$$

where yᵢ is the expected outcome (i.e., win or lose the case) and ŷᵢ is the predicted outcome for the ith data point.

The choice of loss function may depend on, for example, the nature of the legal case being analyzed and the desired output of the neural network. In the example embodiment, minimizing the MSE or MAE loss functions may result in a neural network that accurately predicts the case value amount based on the given input variables.

In some embodiments, a feedforward neural network (FNN) architecture described as follows may be used.

A layer may have 10 neurons, corresponding to each of 10 factors (x_1 to x_10). These neurons may receive the input data (e.g., for each case) and pass it on to the next layer.

One or more hidden layers may each include a certain number of neurons. A choice of the number of hidden layers and neurons may depend on the complexity of the problem and the amount of data available for training. For example, one hidden layer containing, for example, 32 neurons may be used. Each neuron may use an activation function, such as ReLU or sigmoid, to introduce non-linearity to the model.

An output layer may include a single neuron, which represents the predicted case value amount. This neuron may use a linear activation function since a continuous value (regression problem) may be predicted.

To train the neural network, a database including historical case records with the 10 input factors and their corresponding case value amounts. This data may be used to train the network using a stochastic gradient descent algorithm (SGD) and a variation of it (e.g., Adam) and an appropriate loss function using a mean absolute error (MAE).

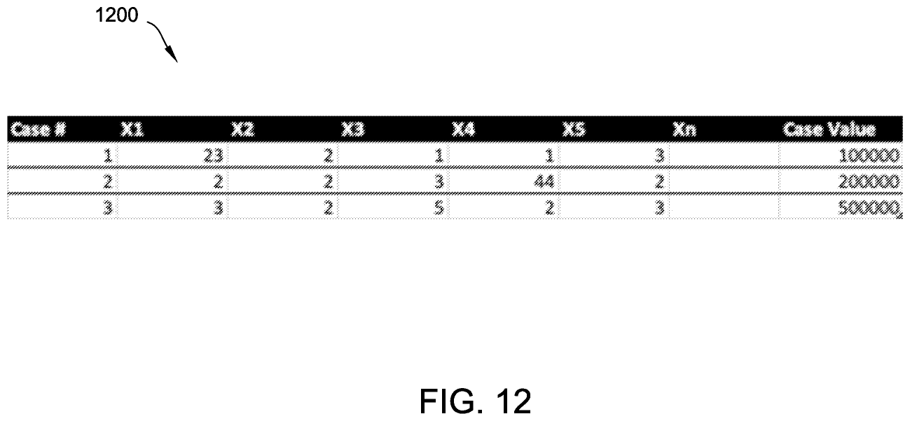

FIG. 12 illustrates an example data structure 1200 for training a neural network model that may be used by analytics system 100 (shown in FIG. 1). In some embodiments, the input format of the content data and/or case record may be represented as a matrix (e.g., data structure 1200), in which each row corresponds to a case and each column may correspond to one of the factors (features) relating to the case. The matrix may be denoted as ƒX∈R^{m×n} where m is the number of legal cases and n is the number of features. In some example embodiments, there may be 10 features, so n=10. Examples of features may include: (1) Past Medical Expenses to Date (x₁); (2) Future Medical Expenses (x₂); (3) Past Lost Wages (x₃); (4) Future Lost Wages (x₄); (5) Property Damage (x₅); (6) Non-Economic Damages (x₆); (7) Recoverable Attorneys Fees at Trial (x₇); (8) Punitive Ask (x₈); (9) Likelihood of Punitive Damages (x₉); and/or (10) Damage Cap (x₁₀).

Each case i may be represented as a feature vector ƒ{x}i=[x{1i}, x_{2i}, . . . , x_{ni}]∈ [symbol] o{R}\hat{ }n corresponds to the value of feature j in case i.

In this formula, in the pre-processed input matrix, each element xⱼᵢ′ may be the standardized value of feature j in case i. The mean (μₙ) and standard deviation (σₙ) may be calculated for each feature j using the training data.

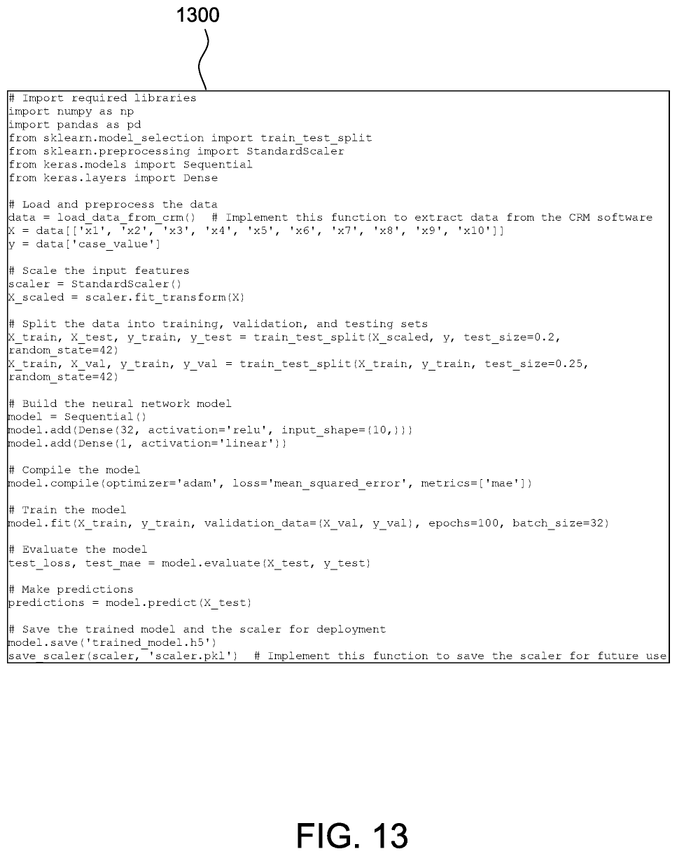

FIG. 13 is an example pseudocode 1300 that can be used to build a neural network model that may be used by analytics system 100 (shown in FIG. 1). A data pipeline that may be implemented using pseudocode 1300 to train the neural network with the historical content data may include the following:

Data extraction: Extract the relevant data (e.g., the 10 input factors and the case values) from the historical case records. This may be done by querying the database or using APIs, depending on its capabilities.

Data pre-processing: Clean and pre-process the extracted data. This step may include (a) handling missing or incomplete data, for example, by filling missing values with appropriate methods, such as mean or median imputation, or remove incomplete records if necessary; (b) feature scaling, for example, by normalizing and/or standardizing the input features to ensure that they have similar scales, which can help the neural network learn more efficiently; and/or (c) data encoding, for example, any of the input factors are categorical, converting the input factors into numerical values using techniques such as one-hot encoding.

Data splitting: Split the pre-processed data into training, validation, and testing sets. For example, 70-80% of the data may be used for training, 10-20% for validation (e.g., for hyperparameter tuning and model selection), and the remaining 10% for testing (e.g., to evaluate the model's performance on unseen data).

Model training: Train the neural network using the training set, for example, by adjusting hyperparameters, such as learning rate, number of hidden layers, and neurons in each layer, based on the performance on the validation set.

Model evaluation: After training the model and selecting the best set of hyperparameters, evaluate the model's performance on the test set, for example, by calculating performance metrics such as mean squared error (MSE) or mean absolute error (MAE) to quantify the model's accuracy.

Model deployment: Once the neural network is trained and evaluated, deploy it in a production environment, where the neural network may be used to predict case values based on the input factors.

Data pipeline automation: Automate the data pipeline to periodically retrain the model with new data, ensuring that the model stays up-to-date with the latest trends and patterns in cases.

In summary, the data pipeline may include data extraction from the historical content data and/or historical case records, pre-processing, splitting the data into training, validation, testing sets, training and evaluating the neural network model, deploying the model in a production environment, and/or automating the pipeline to keep the model up-to-date.

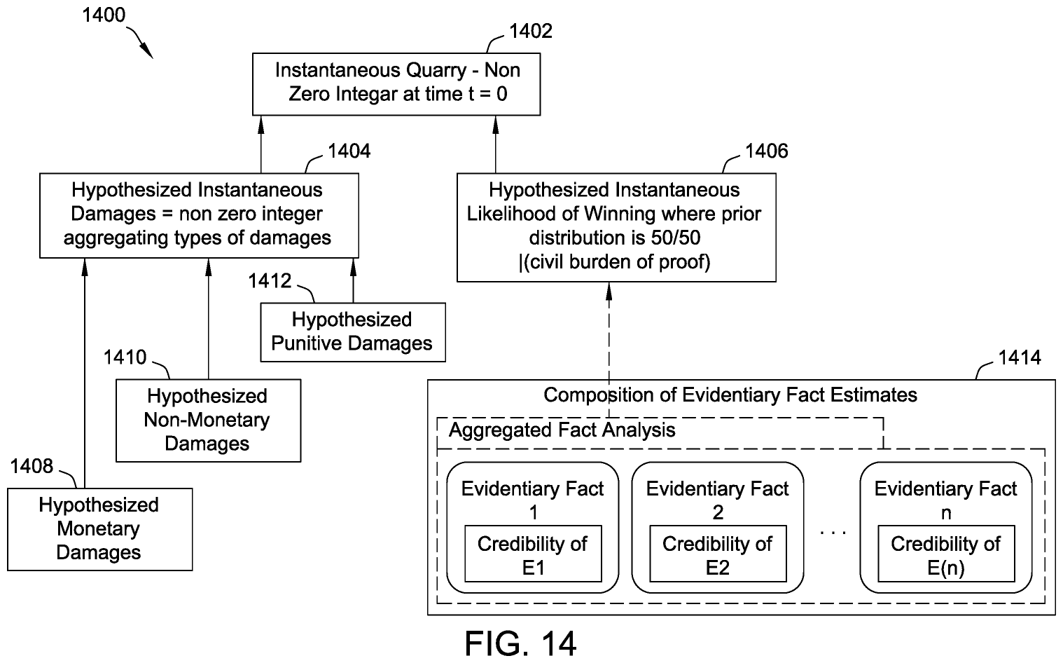

FIG. 14 is a flow diagram 1400 of an example application of analytics system 100 (shown in FIG. 1). Instantaneous quarry 1402 is a predicted or hypothesized case value amount at a given time t. The applicant extracts information from content data (e.g., evidence) that includes categories of information (e.g., communications, medical records, filings, investigations, and/or accounting). Instantaneous quarry 1402 may be an ongoing representation of an ideal outcome in a given case (e.g., a maximum case value amount). At time t=0, instantaneous quarry 1402 may represent the initial maximum projected outcome of a give case based upon the initially received content data (e.g., from the initial client intake). At each time t, instantaneous quarry 1402 may be a product of instantaneous damages 1404 times a likelihood 1406 of winning the case.

Instantaneous damages 1404 may be a cumulative distribution function describing a likelihood that damages are at least x given input that may include hypothesized monetary damages 1408, hypothesized non-monetary damages 1410, and hypothesized punitive damages 1412, and may be a prospective measure of the maximum amount of damages in each category. Hypothesized monetary damages 1408 may include a sum of, for example, medical expenses, increased cost of living, lost wages, attorney's fees, and/or other monetary amounts. Hypothesized non-monetary damages 1410 may include a sum of, for example, pain and suffering, loss of consortium, humiliation and reputational harm, diminished earnings capacity, and/or other non-monetary factors. Hypothesized punitive damages 1412 may include, for example, a multiple of 1-5 depending on, for example, a perceived culpability of defendants.

Likelihood 1406 of winning the case (e.g., a liability) at time t=n may be a posterior distribution function. Arguments of the posterior distribution function may be derived from facts 1414 that need to be proved in order to determine a case outcome, such as those indicated in jury instructions, and a credibility or likelihood that each fact can be proven. In some embodiments, likelihood is a conditional probability computed on the bases of a Bayesian network. A Bayesian network represents the causal probabilistic relationship among random variables and their conditional dependencies. It provides a representation of a joint probability distribution. Each node of the Bayesian network is associated to a separate random variable. For example, each variable may be a continuous estimation of the jury accepting or believing each fact given the evidence.

Instantaneous quarry 1402 may be iterated at periodic intervals to provide an instantaneous expected case value (e.g., to account for newly available data). Changes in the underlying data set may be reflected as binary conditional modification.

The computer-implemented methods discussed herein may include additional, less, or alternate actions, including those discussed elsewhere herein. The methods may be implemented via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based on example inputs in order to make valid and reliable predictions for novel inputs.

Additionally or alternatively, the machine learning programs may be trained by inputting sample data sets or certain data into the programs, such as images, object statistics and information, historical estimates, and/or actual repair costs. The machine learning programs may utilize deep learning algorithms that may be primarily focused on pattern recognition, and may be trained after processing multiple examples. The machine learning programs may include Bayesian program learning (BPL), reinforced learning techniques, voice recognition and synthesis, image or object recognition, optical character recognition, and/or natural language processing—either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based on the discovered rule, accurately predict the correct output. In unsupervised machine learning, the processing element may be required to find its own structure in unlabeled example inputs.

As described above, the systems and methods described herein may use machine learning, for example, for pattern recognition. That is, machine learning algorithms may be used by the analytics computing device to attempt to identify patterns within content data. Further, machine learning algorithms may be used by the analytics computing device to predict case outcomes based on the patterns. Accordingly, the systems and methods described herein may use machine learning algorithms for both pattern recognition and predictive modeling.

In some embodiments, the voice bots or chatbots discussed herein may be configured to utilize AI and/or ML techniques. For instance, the voice bot or chatbot may be a ChatGPT chatbot. The voice bot or chatbot may employ supervised or unsupervised machine learning techniques, which may be followed or used in conjunction with reinforced or reinforcement learning techniques. The voice bot or chatbot may employ the techniques utilized for ChatGPT. The voice bot or chatbot may deliver various types of output for user consumption in certain embodiments, such as verbal or audible output, a dialogue output, text or textual output (such text or graphics presented on a computer or mobile device screen or display), visual or graphical output, and/or other types of outputs.

For the purposes of this discussion, a chatbot or chatterbot is a software application used to conduct an online chat conversation via text or text-to-speech, in lieu of providing direct contact with a live human agent. Chatbots are computer programs that are capable of maintaining a conversation with a user in natural language, understanding their intent, and replying based on preset rules and data. Designed to convincingly simulate the way a human would behave as a conversational partner.

Chatbots are used in dialog systems for various purposes including customer service, request routing, or information gathering. While some chatbot applications use extensive word-classification processes, natural-language processors, and sophisticated AI, others simply scan for general keywords and generate responses using common phrases obtained from an associated library or database.

Most chatbots are accessed on-line via website popups or through virtual assistants. They can be classified into usage categories that include: commerce (e-commerce via chat), education, entertainment, finance, health, news, and productivity.

For the purposes of this discussion, ChatGPT is an artificial intelligence chatbot. It is built on a family of large language models and has been fine-tuned (an approach to transfer learning) using both supervised and reinforcement learning techniques. ChatGPT is a member of the generative pre-trained transformer (GPT) family of language models. It was fine-tuned (an approach to transfer learning) over previous versions. The fine-tuning process leveraged both supervised learning as well as reinforcement learning in a process called reinforcement learning from human feedback (RLHF). Both approaches used human trainers to improve the model's performance. In the case of supervised learning, the model was provided with conversations in which the trainers played both sides: the user and the AI assistant. In the reinforcement learning step, human trainers first ranked responses that the model had created in a previous conversation. These rankings were used to create ‘reward models’ that the model was further fine-tuned on using several iterations of Proximal Policy Optimization (PPO). Proximal Policy Optimization algorithms present a cost-effective benefit to trust region policy optimization algorithms; they negate many of the computationally expensive operations with faster performance. In addition, chatbots similar to and including ChatGPT continue to gather data from users that could be used to further train and fine-tune the chatbot. Users can upvote or downvote responses they receive from ChatGPT and fill out a text field with additional feedback. The reward model of ChatGPT, designed around human oversight, can be over-optimized and thus hinder performance.

Although the core function of a chatbot is to mimic a human conversationalist, ChatGPT represents a type of chatbot that is versatile. For example, it can write and debug computer programs, compose music, teleplays, fairy tales, and student essays; answer test questions (sometimes, depending on the test, at a level above the average human test-taker); write poetry and song lyrics; emulate a Linux system; simulate an entire chat room; play games like tic-tac-toe; and simulate an ATM. ChatGPT training data includes many pages and information about internet phenomena and programming languages, such as bulletin board systems and the Python programming language.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An analytics computing device comprising a processor in communication with a memory, the processor configured to:
store, in the memory, a plurality of documents in association with a case identifier;
electronically extract content data from the plurality of documents using a semantic analysis engine;
generate a case record in the memory including the extracted content data associated with the case identifier, the case record having a predefined data format;
execute a machine learning model configured to output a predicted value amount by inputting at least a portion of the extracted content data included in the case record into the machine learning model, the machine learning model trained using a plurality of historical case records and a plurality of historical value amounts associated with the historical case records, the historical case records including historical content data and having the predefined data format; and
cause the predicted value amount outputted by the machine learning model to be displayed.

2. The analytics computing device of claim 1, wherein the processor is further configured to identify missing content data based on the case record, the missing content data being content data that improves a confidence score associated with generating the predicted value amount by the machine learning model.

3. The analytics computing device of claim 2, wherein the processor is further configured to:
generate an electronic request for the missing content data;
receive a response to the electronic request including the missing content data;
parse the response to extract the missing content data; and
update the case record to include the extracted missing content data.

4. The analytics computing device of claim 1, wherein the processor is further configured to extract text data from the plurality of documents using optical character recognition.

5. The analytics computing device of claim 4, wherein the processor is further configured to extract content data from the text data using machine learning techniques.

6. The analytics computing device of claim 1, wherein the processor is further configured to:
record one or more telephone calls; and
extract content data from the recorded one or more telephone calls.

7. The analytics computing device of claim 1, wherein the processor is further configured to provide user interface data to one or more user computing devices, the user interface data configured to cause the one or more user computing devices to display a user interface.

8. The analytics computing device of claim 7, wherein the user interface is configured to display the predicted value amount output by the machine learning model.

9. The analytics computing device of claim 7, wherein the user interface is configured to prompt a user to upload at least one of the plurality of documents.

10. The analytics computing device of claim 7, wherein the user interface is configured to display at least one of the plurality of documents.

11. A computer-implemented method performed by an analytics computing device including a processor in communication with a memory, the computer-implemented method comprising:
storing, by the analytics computing device, in the memory, a plurality of documents in association with a case identifier;
electronically extracting, by the analytics computing device, content data from the plurality of documents using a semantic analysis engine;
generating, by the analytics computing device, a case record in the memory including the extracted content data associated with the case identifier, the case record having a predefined data format;
executing, by the analytics computing device, a machine learning model configured to output a predicted value amount by inputting at least a portion of the extracted content data included in the case record into the machine learning model, the machine learning model trained using a plurality of historical case records and a plurality of historical value amounts associated with the historical case records, the historical case records including historical content data and having the predefined data format; and
causing, by the analytics computing device, the predicted value amount outputted by the machine learning model to be displayed.

12. The computer-implemented method of claim 11, further comprising identifying, by the analytics computing device, missing content data based on the case record, the missing content data being content data that improves a confidence score associated with generating the predicted value amount by the machine learning model.

13. The computer-implemented method of claim 12, further comprising:
generating, by the analytics computing device, an electronic request for the missing content data;
receiving, by the analytics computing device, a response to the electronic request including the missing content data;
parsing, by the analytics computing device, the response to extract the missing content data; and
updating, by the analytics computing device, the case record to include the extracted missing content data.

14. The computer-implemented method of claim 11, further comprising extracting, by the analytics computing device, text data from the plurality of documents using optical character recognition.

15. The computer-implemented method of claim 14, further comprising extracting, by the analytics computing device, content data from the text data using machine learning techniques.

16. The computer-implemented method of claim 11, further comprising:
recording, by the analytics computing device, one or more telephone calls; and
extracting, by the analytics computing device, content data from the recorded one or more telephone calls.

17. The computer-implemented method of claim 11, further comprising providing, by the analytics computing device, user interface data to one or more user computing devices, the user interface data configured to cause the one or more user computing devices to display a user interface.

18. The computer-implemented method of claim 17, wherein the user interface is configured to display the predicted value amount output by the machine learning model.

19. The computer-implemented method of claim 17, wherein the user interface is configured to prompt a user to upload at least one of the plurality of documents.

20. At least one non-transitory computer-readable media having computer-executable instructions embodied thereon, wherein when executed by an analytics computing device including a processor in communication with a memory, the computer-executable instructions cause the processor to:
store, in the memory, a plurality of documents in association with a case identifier;
electronically extract content data from the plurality of documents using a semantic analysis engine;
generate a case record in the memory including the extracted content data associated with the case identifier, the case record having a predefined data format;
execute a machine learning model configured to output a predicted value amount by inputting at least a portion of the extracted content data included in the case record into the machine learning model, the machine learning model trained based on a plurality of historical case records and a plurality of historical value amounts associated with the historical case records, the historical case records including historical content data and having the predefined data format; and
cause the predicted value amount outputted by the machine learning model to be displayed.
